(19) United States
(12) Patent Application Publication
(10) Pub. No.: US 2013/0318094 A1
(43) Pub. Date: Nov. 28, 2013

(54) INDEXING AND EXECUTION OF SOFTWARE APPLICATIONS IN A NETWORK

(71) Applicants: Roberto Agro, Bourg La Reine (FR); Romain Piegay, Paris (FR)

(72) Inventors: Roberto Agro, Bourg La Reine (FR); Romain Piegay, Paris (FR)

(73) Assignee: FRANCE TELECOM, Paris (FR)

(21) Appl. No.: 13/882,064

(22) PCT Filed: Oct. 26, 2011
(86) PCT No.: PCT/FR11/52497

§ 371 Date: Aug. 8, 2013

(30) Foreign Application Priority Data
Oct. 27, 2010 (FR) 1058862

(51) Int. Cl. G06F 17/30

(52) U.S. Cl. CPC G06F 17/30321
USPC 707/741

(57) ABSTRACT

A method is provided for managing the indexing of a software application, implemented by a multimedia content server (DMS). The method includes the following phases: indexing at least one software application as content in a content indexing database, by recording metadata indicating that the thus indexed content is a software application and recording a location address of a data file comprising a software module designed to execute the at least one software application; and transmitting the metadata and the location address to a drive device (DMC), serving to select an indexed content to be delivered and to drive the delivery of a selected content.

### CROSS-REFERENCE TO RELATED APPLICATIONS

This application is a Section 371 National Stage Application of International Application No. PCT/FR2011/052497, filed Oct. 26, 2011, which is incorporated by reference in its entirety and published as WO 2012/056169 on May 3, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the invention is that of the management of software applications in a network.

More specifically, the invention can be applied to the distribution and execution of software applications on different apparatuses of a network.

In a known way, the UPnP/DLNA (Universal Plug and Play/Digital Living Network Alliance) standard is used to interconnect devices implanted in different apparatuses of a local area network, especially in order to share and render multimedia contents such as images, audio contents or video contents.

In the context of this document, a device is called an UPnP device if it complies with the UPnP standard or another equivalent or derivative standard (for example the DLNA standard), especially if it uses a control protocol complying with such a standard. A device such as this comprises at least one UPnP/DLNA entity (called a device in the UPnP/DLNA standard) and/or implements at least one service defined in the UPnP/DLNA standard.

### BACKGROUND OF THE DISCLOSURE

The UPnP/DLNA standard is becoming widespread as a standard for the sharing, distribution and control of digital multimedia contents.

More specifically, the UPnP standard is a protocol that enables several computers or other information processing devices, which are then called UPnP devices, to be connected in a simple way to one another. This standard is promulgated by the UPnP Forum (http://www.upnp.org/). The sending of UPnP commands enabling the UPnP devices to be made to communicate with one another (these commands are called UPnP actions) and enabling the exertion of control over certain UPnP devices of the network, is based especially on the TCP/IP, UDP and HTTP protocols. SSDP (Simple Service Discovery Protocol) messages make it possible to discover the devices and services available on a network. They work whatever the operating system of the UPnP device.

Thus, the UPnP standard enables an easy sharing of the digital contents, such as photographs, films or music within a network.

However, at present, the inventors have noted that there is no simple and comparable mechanism enabling the distribution and/or execution of software applications, for example interactive software applications of the video game type, on different devices of the network.

### SUMMARY

The invention, in a first aspect, pertains to a method for managing at least one software application implemented by a Digital Media Server (DMS), comprising:
a phase for indexing, in a content indexing database, at least one software application as content by a recording of metadata indicating that said content thus indexed is a software application, and recording a location address of a data file comprising a software module designed to execute said at least one software application;
a phase for transmitting said metadata and said location address to a Digital Media Controller (DMC) serving to select an indexed content to be rendered and to drive the rendering of a selected content.

Thus, in an UPnP context, the invention enables the management of an application like any other multimedia content. This management is made possible through the recording of metadata associated with the applications, as if classic contents were involved. This management is also possible because of the recording of the location of a software module designed to execute the application, i.e. a module without which the application could not be implemented. The transmission of the metadata associated with the applications and of the location addresses of the software modules to the Digital Media Controller (DMC) enables it to implement the software application in the same way as for classic contents.

According to one particular embodiment, the method comprises a phase for transmitting, to at least one multimedia Digital Media Renderer (DMR) to which an indexed content is to be rendered, said software module when the indexed content is a software application.

Thus, when the software application has been selected by the DMC, this software application is executed by the Digital Media Renderer DMR after the software module has been transmitted to the Digital Media Renderer DMR. This enables the rendering device to have available all the elements needed to execute the application.

According to this aspect of the invention, the multimedia content rendering device has increased flexibility because it does not need to preliminarily possess the software module associated with the software application to be rendered.

According to one embodiment, said pieces of metadata comprise an identification of a class of contents to which said software application belongs, said class of contents being proper to contents which are software applications.

Thus, the invention proposes a specific indexing of software applications in using a novel class of contents pertaining to the software applications in addition to the known classes such as those dedicated specifically to music, photos or video.

The metadata include an identification of the class of membership of the indexed object, in this case the novel class of “software applications” objects dedicated to software applications.

The metadata identifying this specific class with the software applications comprise especially descriptive data of the software module or modules associated with each software application.

For example, said metadata include at least one piece of information belonging to the group comprising:
a version of an execution engine of said software module;
a list of at least one peripheral required to execute said software application;
a list of at least one optional peripheral to execute said software application;
a piece of information on a degree of expert knowledge expected for a user of said software application;
a piece of information on the operating system required to execute said software application;
a piece of information on an execution engine required to execute said software application.

These pieces of metadata respectively pertaining to a content, an execution environment and the location of an execution engine furthermore enable independent management of the pieces of information pertaining to a given software application. This independent management especially optimizes the resources of a home network. Indeed, in the particular case where certain developers of software applications choose to develop a sufficiently generic execution engine that is not specific to a precise software application, it is possible to address and index the location of a same execution engine for different software applications.

According to one particular embodiment, the multimedia contents server is an UPnP multimedia contents server and said class is a class derived from the UPnP class called the “object.item” class.

According to this particular embodiment, the specific indexing implemented by the invention, enabling the indexing of objects which are not multimedia contents but software applications, is also adapted to being understood by an UPnP multimedia content server. Indeed, this indexing implements a class derived from the UPnP class called “object.item”, for example: object.item.applicationItem, and contains metadata proper to a software application,

According to another particular embodiment, the multimedia contents server is a UPnP multimedia contents server and said class is a class derived from the UPnP class called “object.container”.

Thus, in this other particular embodiment, the indexing phase implements a class derived from the “object.container” type UPnP class defining a container, i.e. a set of several multimedia contents, for example: object.container.applicationItem and contains metadata proper to a software application.

Advantageously, said indexing phase comprises a step for determining and recording at least one piece of metadata representing a location and/or an identifier of at least one multimedia content used by said software application during its execution.

Through this step of determining and recording at least one piece of metadata representing a location and/or an identifier of at least one multimedia content (images, video, sounds, etc), it is possible to list and assemble all the contents called up by a software application during its execution. This step therefore increases the speed of execution of a software application because the rendering device does not have to search for the contents called up during the rendering of the software application, their location having been preliminarily established and stored by the multimedia contents server.

Advantageously, said indexing phase furthermore comprises a step for determining and recording at least one piece of metadata representing a location and/or an identifier of an execution engine associated with said software application when said software module needs to be executed by an execution engine.

The present invention thus introduces the possibility of the independent distribution, to a rendering device connected to the home network, of an execution engine specific to the software module of a software application when this device does not possess it.

Thus, the method enables a “lighter” storage of a software application within a multimedia contents server. Indeed, the indexing of the execution engine associated with a software application does not require the physical presence of the execution engine on the multimedia contents server but determines and records a piece of metadata representing a location of the execution engine. It is thus possible for the desired execution engine to be physically absent from the multimedia contents server but available with a device accessible from the network.

The invention therefore optimizes the distribution of the software applications on a set of devices constantly or not constantly connected to a network, for example a home network.

Advantageously, the method for managing a software application according to the invention also comprises a phase for updating said indexing database when a novel version of a software application or when a novel software application is detected.

Thus, it is possible to take account of a novel version of a software application. For example, the method creates a new piece of metadata representing a location of the latest version of the execution engine associated with a software application. According to a predetermined setting of parameters, it is possible to set up a hierarchy of the versioning of the metadata of a software application, for example as a function of the environment of execution associated with each version.

In a second aspect, the invention also pertains to a method for driving implemented by
a Digital Media Controller (DMC) characterized in that it comprises:

a step for obtaining, from a multimedia contents server, metadata of at least one content indexed in a contents indexing database and a location address of at least one data file associated with said indexed content;
a step for transmitting, to a multimedia content rendering device, metadata, said location address and a command for rendering at least one indexed content;
said command for rendering being intended, when said metadata indicates that said at least one indexed content is a software application, for activating an execution of said software application by means of a software module encoded in said data file.

Thus, the driving is truly optimized because it consists in processing specifically one software application as simply as a classic audio or video type multimedia content.

The present invention indeed makes it possible to further develop the driving capacities of a Digital Media Controller (DMC) in enabling the processing of a novel type of objects which are not multimedia contents but software applications.

The software application is indeed identified as a multimedia object by a set of indexing metadata liable to be obtained from the server.

In processing these specific pieces of metadata, the Digital Media Controller (DMC) contents, location addresses of data files associated with the indexed contents and a command for rendering said indexed content.

In particular, when the metadata obtained indicates that the indexed content is a software application, the rendering command is such that it activates an execution of the software application by means of a software module indicated in the associated data file.

According to one embodiment, the method for driving comprises a step for verifying the compatibility of the rendering device with said indexed content from a piece of information on an environment for executing said Digital Media Renderer (DMR) and a piece of information representing at least one peripheral of said Digital Media Renderer (DMR).

Thus, the capacities for verifying and controlling compatibility between a rendering device and an indexed content are extended to ensure that the rendering device is capable of rendering a content corresponding to a software application.

According to one embodiment, the method for driving comprises:
a first step for verifying an environmental compatibility between:
   a piece of metadata representing an environment of execution of said selected multimedia content, and
   said at least one piece of information on an environment of execution of said at least one Digital Media Renderer (DMR),
a second step for verifying a hardware compatibility between:
   a piece of metadata representing peripherals used by said software application;
   said at least one piece of information representing preliminarily obtained peripherals.

Thus, in addition to the classic checking of formats/protocols, the driver device makes other checks of compatibility of the rendering device with the device that the user wishes to use, in relation especially to the environment and to the presence of the peripherals required by the software application to be rendered. The driver device verifies this compatibility by comparing for example the metadata of the software application with the rendering capacities of the rendering device.

According to a third aspect, the invention also pertains to a method for rendering, implemented by a Digital Media Renderer (DMR) multimedia contents, characterized in that it comprises:
a step for receiving, from a location address, pieces of metadata and a command for rendering a content indexed in a multimedia contents indexing database and,
in response to said rendering command, when said pieces of metadata indicate that the indexed content is a software application, a step for downloading a software module to said location address and activating the execution of said software application by means of said software module.

Thus, the invention enables the rendering of the software applications as simply as in the case of an audio or video type classic multimedia content.

The obtaining of the software module is advantageous because it does not mobilize major reception resources within the rendering device since this device receives a piece of data representing a location of the relatively small-sized software module.

Besides, each device is capable of deferring or not differing the physical downloading of the software module.

According to one embodiment, the method for rendering a software application comprises, when said software module requires an execution engine:
a step for verifying a presence, in the apparatus implementing said Digital Media Renderer (DMR), of an execution engine of said software module;
a step for obtaining said execution engine when said execution engine is absent.

Thus, the flexibility of operation of the rendering device is increased. Indeed, it is possible to independently eliminate or download the execution engine of a software application. For example, for a smartphone, the method enables a partial and independent release of memory of at least one execution engine needed to execute the software module of a software application. The rendering device will indeed be capable of subsequently locating and downloading the execution engine when the execution of the software application will be requested by a user.

Furthermore, in the particular case where certain software applications developers choose to develop a sufficiently generic execution engine, it is possible to download, from the home network, only contents (images, sounds, etc) called up by the software application if the execution engine of the software application is already present in the rendering device that the user wishes to use.

The invention also pertains to a Digital Media Server (DMS) comprising:
means for indexing, in a content indexing database, at least one software application as content, by recording of metadata indicating that said content thus indexed is a software application and recording a location address of a software module designed to execute said at least one software application;
means for transmitting said metadata and said location address to a Digital Media Controller (DMC) serving to select an indexed content to be rendered and to drive the rendering of a selected content.

The invention also pertains to a Digital Media Controller (DMC) designed for the driving of rendering devices comprising:
means for obtaining, from a multimedia contents server, metadata of at least one content indexed in a content indexing database and a location address of at least one data file associated with said indexed content;
means for transmitting, to a multimedia content rendering device, metadata, said location address and a command for rendering said indexed content, said command for rendering being intended for activating, when said pieces of metadata indicate that said indexed content is a software application, an execution of said software application by means of a software module encoded in said data file.

The invention also pertains to a Digital Media Renderer (DMR) multimedia content comprising:
means for receiving a command for rendering an indexed content in a multimedia content indexing database, a location address of a data file associated with said indexed content and metadata of said indexed content;
means for downloading a software module to a location address, in response to said rendering command when said pieces of metadata indicate that the indexed content is a software application, and for activating the execution of said software application by means of said software module.

### LIST OF FIGURES

Other features and advantages of the invention shall appear more clearly from the following description of a particular embodiment given by way of a simple illustratory and non-exhaustive example, and from the appended drawings, of which:

FIG. 1 illustrates an example of a simplified structure of a multimedia contents server;

FIG. 2 illustrates an example of a simplified structure of a device for driving a software application;

FIG. 3 illustrates an example of a simplified structure of a device 422 for rendering a software application;

FIG. 4 illustrates an example of a representation of the UPnP AV architecture;

FIG. 5 presents the main phases and steps of the method for managing indexing data of a software application according to one embodiment;

FIG. 6 shows the main steps of the method for selecting a software application and for selecting the rendering device 422 of said software application according to one embodiment;

FIG. 7 presents the main steps of the method for rendering a software application according to one embodiment;

FIG. 8 illustrates an example of a sequence chart of a system for managing a software application according to one embodiment.

### DESCRIPTION OF ONE EMBODIMENT

General Principle

The general principle of the invention relies on the specific indexing, selection and rendering of software applications within a network through the use of UPnP devices of a network.

The invention proposes a mechanism for managing software applications within a UPnP network implementing UPnP devices: this software applications management implies modifications of mechanisms for indexing, selecting and rendering contents as defined in the UPnP standard. These are mechanisms to be applied to video and/or audio type classic multimedia contents. These standard UPnP mechanisms are recalled here below.

The management of software applications according to the invention limits the resources needed to execute a software application through the use, for this execution, of the UPnP devices present in the network for managing multimedia contents.

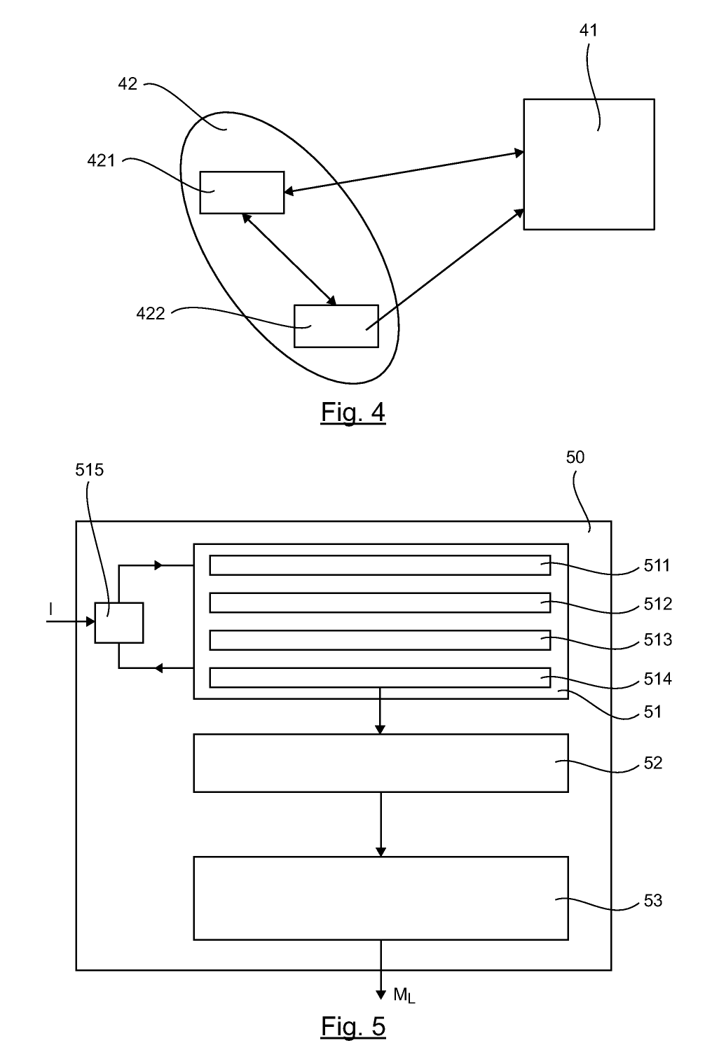

The UPnP AV/DLNA (UPnP Audio and Video) architecture shown with reference to FIG. 4 brings three types of entities into play in a network for the management of the video, audio and photographic contents:
the multimedia contents server (DMS or “digital media server”) 41: this is a UPnP device which shares its multimedia contents (such as audio, video or images) with the other UPnP devices of the network;
the driver device 421, also called a UPnP control point (CP) or DMC (“digital media controller”): an entity which can detect the UPnP devices and their services, receive events from these devices and control them by sending them UPnP commands (called actions);
the rendering device 422 or DMR (“digital media renderer”) which is a “slave” device in charge of rendering a content to a peripheral of the apparatus that integrates this rendering device 422 (for example a television set, a HiFi system, etc).

The functional assembly constituted by the DMC “control point” and the rendering device 422 or DMR is called a UPnP media reader 42 (abbreviated as DPM or digital media player) and constitutes a second type of rendering device 422. Among the most widespread digital media players, we can especially cite games devices such as the PS3™ or the XBox 360™ and television sets, which can be connected to a network, for example a home network of their owner.

Each of these devices implements services specified by the UPnP. In particular, a rendering device 422 implements a connection management service (called a “ConnectionManager” in the UPnP standard), a rendering control service (RenderingControl in the UPnP standard), a rendering service (“AVTransport” in the UPnP standard).

According to the UPnP standard, the rendering scenario for a classic multimedia content (image, textures, models, 3D, text, music, etc) is the following:
the UPnP control point obtains the location address of a multimedia content to be rendered, i.e. the address of the location of a data file comprising/encoding the data of this multimedia content, by in interrogating the UPnP multimedia contents server, provided with a multimedia content indexing database in the form of a directory of multimedia contents (“Content Directory Service” in the UPnP standard);
the UPnP control point specifies, to the selected UPnP rendering device 422, the location address of the multimedia content by using the “SetAVTransportURI” action of the “AVTransport” service of the UPNP rendering device 422;
the UPnP control point activates the rendering of the multimedia content by invoking the rendering action “PLAY” of the “AVTransport” service of the UPnP rendering device 422;
the rendering device 422 obtains the multimedia content proper by sending an HTTP “GET” request to the entity designated in the location address of the multimedia content sent by means of the “SetAVTransportURI” action.

In the UPnP standard, when the rendering device 422 chosen is of the DMR type, we refer to a three-box model because three distinct UPnP devices have to act to implement the rendering of multimedia content (DMS+DMC+DMR). When the rendering device 422 chosen is of the DMP type, we refer to a two-box model because two distinct UPnP devices have to act to implement the rendering of a multimedia content (DMS and DMP), where the DMP combines, in this two-box model, the functions of the DMC and of the DMR.

These three UPnP entities are modified to implement the invention, the scenario for rendering a classic multimedia content being adapted to take account of the specific characteristics of a content belonging to the “software application” class. The modifications made to each of these entities are described here below.

Multimedia Contents Server 41

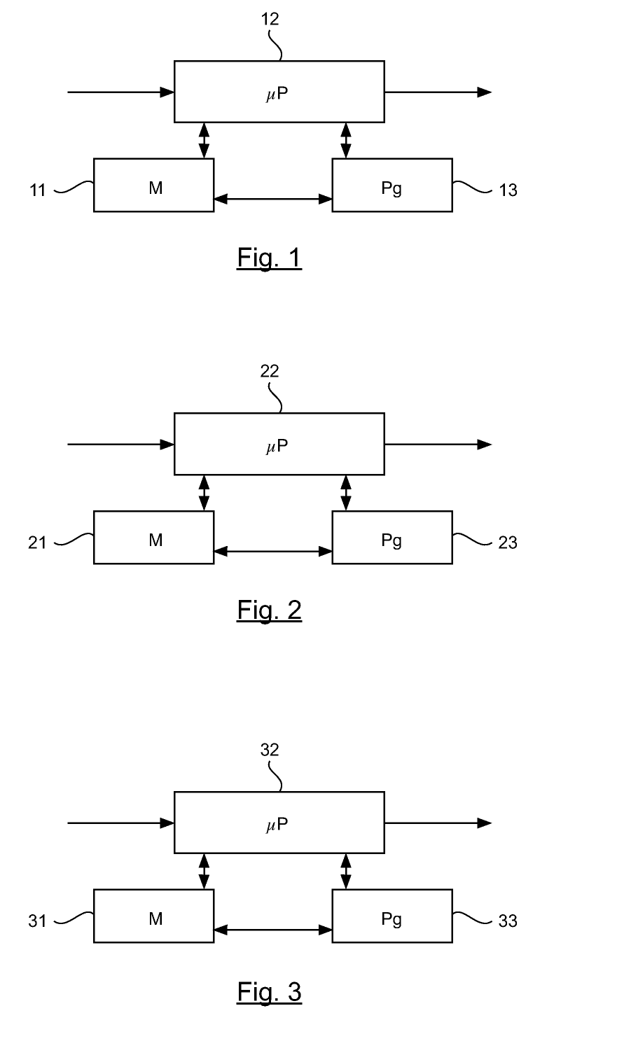

FIG. 1 illustrates an example of a simplified structure of a multimedia contents server 41 according to one embodiment of the invention.

For example, the multimedia contents server comprises a memory 11 constituted by a buffer memory, a processing unit 12 equipped for example with microprocessor and driven by the computer program 13, implementing a software application indexing method according to the invention.

At initialization, the code instructions of the computer program 13 are for example loaded into a memory and then executed by the processor of the processing unit 12. The processing unit 12 inputs at least one software application to be indexed. The microprocessor of the processing unit 12 implements the steps of the software application indexing and management method described here below, according to the instructions of the computer program 13 to index and manage at least one software application in a device of the network to which the multimedia contents server is itself connected.

To this end, the multimedia contents server comprises, in addition to the buffer memory 11, means for indexing, in an indexing database, at least one software application as a multimedia content by the recording of metadata of this software application and the recording of at least one software module designed to execute said at least one software application, means for transmitting, to a Digital Media Controller (DMC), metadata of a multimedia content to be rendered on at least one device 422 for Digital Media Renderer (DMR), means for distributing, to at least one device 422 for Digital Media Renderer (DMR), a software module associated with a multimedia content selected by said Digital Media Controller (DMC), said selected multimedia content being a software application. These means are driven by the microprocessor of the processing unit 12.

Through these means, the contents server 41 is capable of managing and indexing a novel type of contents, namely software applications. The method of indexing implemented by the contents server 41 is described in detail here below, in recalling first of all the indexing method defined in the UPnP standard.

Indexing of Contents by a Multimedia Contents Server According to the UPnP Standard

As specified here above, the role of a multimedia contents server is to share a multimedia contents (music, video, etc) on a UPnP network. To this end, the contents server 41 is designed to index multimedia contents. The indexing method defined in the UPnP standard is recalled here.

Each audio, video type multimedia content is characterized by characteristic data called metadata stored in the multimedia content indexing database of the multimedia contents server (directory of multimedia contents CDS). The multimedia contents server transmits all or part of the pieces of metadata from one or more multimedia contents to the DMC control point or to the DMP media reader which requests it, these pieces of metadata comprising a location address (URI or Uniform Resource Identifier) which can be used to send a request for obtaining multimedia content data proper.

A major function of the multimedia contents server is the indexing of these multimedia contents to build a content indexing database which can be interrogated by the UPnP devices of the network.

The indexing of a multimedia contents server consists classically in obtaining, for each multimedia content to be indexed, a set of metadata, and in storing this metadata in a multimedia content indexing database in association with a multimedia content identifier.

An example of metadata characteristic of a photograph is reproduced especially in Appendix 1. In another example, the multimedia contents server will store metadata ID3 that can be inserted into an audio content such as MP3 and corresponding to information such as the title, the name of the artist, comments or again the date of release of the musical composition. When it is an image content, the multimedia contents server stores metadata corresponding to the information on geolocation of the images, the extension and the headers of the images determining their format (audio and video codecs, resolution, bit rate, etc).

These pieces of metadata are, for the most part, directly specified in the UPnP standard but they could also be proprietary data.

The multimedia content indexing database of a UPnP multimedia content server is accessible through the UPnP service called the CDS (Content Directory Service”) and is organized in the form of a tree of objects.

For each multimedia content constituting an object, one or more data fields are used to store the properties of this object: these data fields constitute the metadata of this object.

One of the properties of an object is its class of membership. Each object is indeed allocated to an object class, the name of this object class being memorized in a data field called “upnp:class”.

The classes of objects are organized in a hierarchical and tree-like fashion, certain classes being derived from other classes, depending on what is usual in object-oriented design. The root of this tree structure is the basic class called the “object”. From this basic “object” class, two main classes are derived: firstly, the “object.item” class defining an element or a multimedia content (a piece of music and/or sound and/or video sequence and/or image and/or text, etc) and secondly the “object.container” class defining a container, i.e. a set of several multimedia contents.

From the “object.item” class there are derived for example the classes “object.item.textItem”, defining a textual content and an “object.item.audioItem”, defining an audio content.

With each multimedia content (i.e. with each object belonging to “object.item” class), one or more resources are associated, each defining a multimedia content data file.

For each resource, one or more data fields are used to memorize the properties of this resource. These data fields are part of the metadata of the associated multimedia content. Among the properties of a resource, there are known ways of using the following in the UPnP standard:
an identifier of the file or location address, usually stored in the form of an URI (Uniform Resource Identifier) identifier comprising an identifier of the header of the network with which this file can be obtained, generally an address of a Digital Media Server DMS;
an encoding format, a file comprising an audio content which for example can be available in several formats (compressed MP3 or non-compressed PCM, etc);
a resolution, when the multimedia content is a photo or a video content available in several resolutions;
an MIME type data encoding identifier of the multimedia content encoded in the file, for example “audio/mpeg”;
a transport protocol to be used to transport the data of the file during the rendering of the multimedia content (“http-get”, “rstp”, etc).

An object may have several associated resources if, for example, the multimedia contents server is capable of performing several transcoding or re-dimensioning functions (for example a photo available in different resolutions, an audio track available in MP3 compressed format or non-compressed format (using PCM or pulse-coded modulation)).

Indexing of a Software Application in a UPnP Multimedia Contents Server

In the context of the invention, it is planned to use an UPnP contents server 41 to index a novel type of content: a software application. In this context, a software application is defined as a composite object for which the different constituent elements are the following:
at least one software module in the form of data files comprising a program code, and
one or more multimedia contents to be rendered during the execution of the software application by means of the software module.

Here below, we shall consider that a software application is managed like a multimedia content and has the particular feature of being constituted by classic multimedia contents (such as images, textures, 3D models, text, music, sound extracts, etc) and a software module.

The software module can take the form of an autonomous program (for example a program in the form of executable code, encoded in a “.exe” extension file in the case of the Windows operating system) or a program requiring an execution engine (for example an executable “.jar” file, a script file “.js”).

A software module requiring an execution engine is for example:
a script or set of several scripts requiring an execution engine playing the role of a script interpreter capable of interpreting this script, or
a software component encoded in an exploitable language by an execution engine in the form of a virtual machine, for example in Java, Flash or other languages.

In the case of a software application that is a video game, the script is used to feed a game engine and describe the shifts and interactions between players, cameras, enemies, furnishings etc.

Pieces of metadata are used to index the software application in an indexing database of the multimedia contents server, called a CDS or Content Directory Service according to the UPnP standard. These pieces of metadata comprise descriptive data of the different elements constituting the software application, especially:
the environment of execution of the software module, indicating especially at least one operating system compatible with the execution of this software module and, as the case may be, compatible with the execution engine;
required/optional peripherals to execute the software application;
optionally, a downloading address and/or an identifier of an execution engine, when this is necessary;
a downloading address and/or an identifier of at least one multimedia content to be rendered during the execution of the software application.

In order to enable the differentiated processing of the software application type contents, a novel class of object adapted and proper to the software application is defined.

This class is called the “software applications” class. This software applications class is derived from the “object.container” class (in this case an application is seen as a set of multimedia contents) or derived from the “object.item” class (in this case a software application is seen as a set of multimedia contents), for example:
object.container.applicationContainer or
object.item.applicationItem.

More specifically, the indexing of a software application as a multimedia content in a UPnP multimedia contents server consists in identifying this software application as a unique object belonging to this novel class and capable of being rendered by a UPnP rendering device 422. In particular, the pieces of metadata recorded for a multimedia content belonging to this novel class indicate that the indexed multimedia content is a software application. This class of content is therefore proper to the software applications and is defined to enable the adapted management of these particular contents constituted by the software applications.

Thus, according to the invention, the pieces of metadata of a software application are recorded in the indexing database. The software module is stored in the multimedia contents server or on a distant server, for example a server accessible through the Internet. In both cases, the multimedia contents server records a location address of a data file comprising a software module, namely the address to which a rendering data is likely to download this data file by sending an HTTP request.

The indexing method enables the management within a multimedia contents server of a software application like a classic multimedia content. This is also the case for various UPnP devices of the network.

The multimedia contents (images, audio contents, video contents, etc) possibly described by the metadata and liable to be rendered during the execution of the software application are stored either on the multimedia contents server or on another server with which these multimedia contents can be obtained.

The execution engine, possibly necessary depending on the nature of the software module and taking for example the form of a virtual machine or a program code interpreter, is not necessarily stored in the multimedia contents server 41. It can be downloaded online or on another server if the device on which the software module has to be executed has already been provided with an execution engine of this kind.

Here below, we present an embodiment of the invention in which the software applications are video games. It is clear that this embodiment in no way restricts the scope of the claims and that the invention can also be implemented for any type of software application involving the rendering of multimedia contents (images, audio contents, video contents) such as for example interactive books (in which the engine makes it possible to launch the rendering of a content independently of the engine), text processing, interactive DVD, etc.

The invention can be applied quite particularly well to the case of a distributed software application in the form of a software module (representing the execution logic of the multimedia contents of the software application) implemented by means of a virtual machine (representing the execution module) and one or more multimedia contents to be rendered during the execution of the software application by means of the software module.

Rendering Device 422

FIG. 3 illustrates an example of a simplified structure of a rendering device 422 according to one embodiment of the invention.

For example, the rendering device 422 comprises a memory 31 constituted by a buffer memory, a processing unit 32 equipped for example with a microprocessor and driven by the computer program 33 implementing a method for rendering a software application according to the invention.

At initialization, the code instructions of the computer code 33 are for example loaded into a memory and then executed by the processor of the processing unit 32. The processing unit 32 inputs at least one list of indexing data. The microprocessor of the processing unit 32 implements the steps of the method for executing a software application described here above, according to the instructions of the computer program 33, to execute at least one software application preliminarily distributed by the distribution device according to the invention.

Thus, the rendering device 422 forms a device for executing a software application and comprises, in addition to the buffer memory 21, first means for receiving metadata (M_{AS}) and a command (O) for rendering a multimedia content selected by a Digital Media Controller (DMC), said multimedia content corresponding to a software application, second means for receiving a software module (M_{L}) of said selected multimedia content, transmitted by a multimedia content server (TMS), means for verifying a presence of an execution engine associated with said multimedia content, when said software module requires an execution engine, means for obtaining said execution engine (ME) associated with said multimedia content when said software module requires an execution engine and when said execution engine is absent from said Digital Media Renderer 422 (DMR), means for rendering said selected multimedia content. These means are driven by the microprocessor of the processing unit 32.

In accordance with the UPnP standard, the rendering device 422 implements a connection management service called a “ConnectionManager” by means of which a UPnP checkpoint is liable, through the dispatch of a command called “GetProtocolInfo”, to obtain in return a list of protocols and MIME types which the DMR rendering device 422 is capable of interpreting and decoding to render a resource of an encoded multimedia content. In response to this command, the DMR rendering device 422 sends a data structure called “Sink” comprising the requested information.

At reception of a data structure of this kind, the control point verifies that the rendering device 422 concerned is capable of rendering a selected multimedia content by comparing the metadata of this multimedia content with the rendering capacities of the UPnP rendering device 422.

In addition to the functions provided in the UPnP standard, the rendering device 422 is liable to be interrogated by means of a request (UPnP action), called for example “GetEnvironmentDescription”, the rendering device 422 giving the following information in response to such a request:
a piece of information on the execution environment of the rendering device 422, especially on the operating system in which the rendering device 422 is executed;
a piece of information representing peripherals of the equipment implementing the rendering device 422.

The “ConnectionManager” or “RenderingControl” service implemented by the rendering device 422 according to the UPnP standard is for example extended in order to enable the additional UPnP action “GetEnvironmentDescription”.

In addition, the rendering device 422 is designed so that, when a multimedia content selected for rendering by this rendering device 422 is a software application, it activates an execution of the software application. This execution is activated following the reception of a rendering command coming from the driver device 421 by means of said software module received from the contents server indexing this software application in its contents indexing database.

Driver Device 421

FIG. 2 illustrates an example of a simplified structure of a driver device 421 for driving UPnP entities: such a device is especially capable of driving UPnP contents servers and UPnP rendering devices.

In the embodiment described here, the execution device comprises a memory 21 constituted by a buffer memory, a processing unit 22, equipped for example with a microprocessor and driven by the computer program 23 implementing the method for executing a software application according to the invention.

At initialization, the code instructions of the computer program 23 are for example loaded into a memory and then executed by the processor of the processing unit 22. The processing unit 22 inputs software applications indexing data. The microprocessor of the processing unit 32 implements the steps of the method for selecting a software application, according to the instructions of the computer program 2, to select at least one preliminarily indexed software application.

To this end, the driver device of a software application comprises, in addition to the buffer memory 21, means for transmitting a request (R) for obtaining a plurality of pieces of metadata from an indexing database, pertaining to multimedia contents indexed by a Digital Media Server (DMS), means for obtaining said metadata (M) of said indexing database, means for selecting a multimedia content to be rendered from said metadata obtained, said selected multimedia content being a software application indexed as a multimedia content by said multimedia contents server, means for selecting a Digital Media Renderer 422 (DMR) capable of rendering said selected multimedia content corresponding to said software application, means for transmitting, to said selected rendering device 422, metadata (M_{AS}) of said selected multimedia content corresponding to said software application, means for transmitting a command (O) for rendering said selected multimedia content to said Digital Media Renderer 422 (DMR). These means are driven by the microprocessor of the processing unit 22.

The driver device 421 comprises the functions defined in the UPnP standard for an UPnP control point. It is furthermore modified so as to enable the management of the contents of a novel type, belonging to the “software applications” class described here above. The driver device 421 must especially be capable of interpreting and processing the metadata of a software application as recorded by the contents server 41 during the indexing of a software application. During the display of the contents indexed by a contents server, it is planned, in the user interface of the driver device 421, to represent the contents belonging to the “software applications” class in a manner differently from the representation used for the other contents, for example by means of a different logo, representing this type of content.

Furthermore, as in the UPnP standard, the driver device 421 is responsible for verifying the compatibility between a content selected by a user and the rendering device 422 selected by this user for rendering the selected content. As it happens, when the selected content belongs to the “software applications” class, additional checks have to be made by the driver device 421 from the metadata of the selected software application:
a first step for checking an environmental compatibility between:
   a piece of metadata representing an environment of execution of said selected multimedia content, and
   a piece of information on an environment of execution of the selected rendering device 422,
a second step for checking hardware compatibility between:
   a piece of metadata representing peripherals used by said software application;
   a piece of information representing peripherals of a piece of equipment implementing the selected rendering device 422.

In accordance with the invention, the driver device 421 interrogates the rendering device 422 selected by invoking the UPnP action “GetEnvironmentDescription” described here above in order to obtain the necessary information:
information on the environment of execution of the rendering device 422;
information representing peripherals of a piece of equipment implementing the selected rendering device 422.

Description of One Embodiment of the Method for Managing and Indexing a Video Game Type of Software Application

Here below, we describe an embodiment of the management of a software application of the video game type within a UPnP network. The definition of a video game, the working of the UPnP standard and the classic processing of multimedia contents are also described in detail in order to describe the technical modifications made to each UPnP entity according to the invention.

Definition of a Video Game

Traditionally, a video game is sub-divided into two elements. On the one hand, a set of multimedia contents (images, textures, 3D models, text, music, etc) and on the other hand at least one software module, capable of orchestrating the display of these multimedia contents on the screen so that the player can live his game experience.

More specifically, the software module can take the form of an independent program (for example a “.exe” executable program) or a program requiring an execution engine (for example an “.jar” executable program).

A software module requiring an execution engine is for example a script requiring a script interpreter (playing the role of an execution engine) capable of interpreting this script or a software component executed in a language exploitable by an execution engine taking the form of a virtual machine.

Certain video game developers choose to develop a video game software module that is sufficiently generic, not specific to a precise video game, capable of orchestrating different software programs if the “multimedia content” part is modified.

Sometimes again, the video game software module is an independent program (a “game player”), i.e. a program in the form of an executable code (for example “.exe” or Windows™) and the video game multimedia contents are stored in a format proper to the video game software module.

Certain games are executed by means of an execution engine taking the form of a virtual machine. A virtual machine implements the intermediate code of a software module which has been compiled in a standardized way to be executed on any platform whatsoever having an adequate virtual machine available to it. Thus, a software application that gets executed on a virtual machine is formed by one or more software modules which can be downloaded independently of the virtual machine in question. Among the games implemented on a software machine, we can cite the games or software applications in Flash language (.SWF files), games or software applications in Java (.JAR files), Silverlight, the Lucas Art adventure game (“ScummVM”), etc.

Execution of a Software Application Using UPnP Entities

The scenario of execution of a software application indexed as a content by a UPnP content server takes up, with a few adaptations, the general principles of the scenario for rendering a classic multimedia content (images, textures, 3D models, text, music, etc) as defined in the UPnP standard and takes place as follows:
1. the contents server 41 indexes software applications;
2. the driver device 421 obtains indexed content metadata;
3. a content (in this case a software application) is selected by means of a user interface of the driver device 421;
4. a rendering device 422 is selected by means of a user interface of the driver device 421;
5. metadata of the selected content, forming the rendering parameters, are sent from the driver device 421 to the rendering device 422 and the rendering device 422 downloads, if necessary, an execution engine;
6. the driver device 421 sends a command for activating the rendering of the selected content to the rendering device 422;
7. the software application is executed.

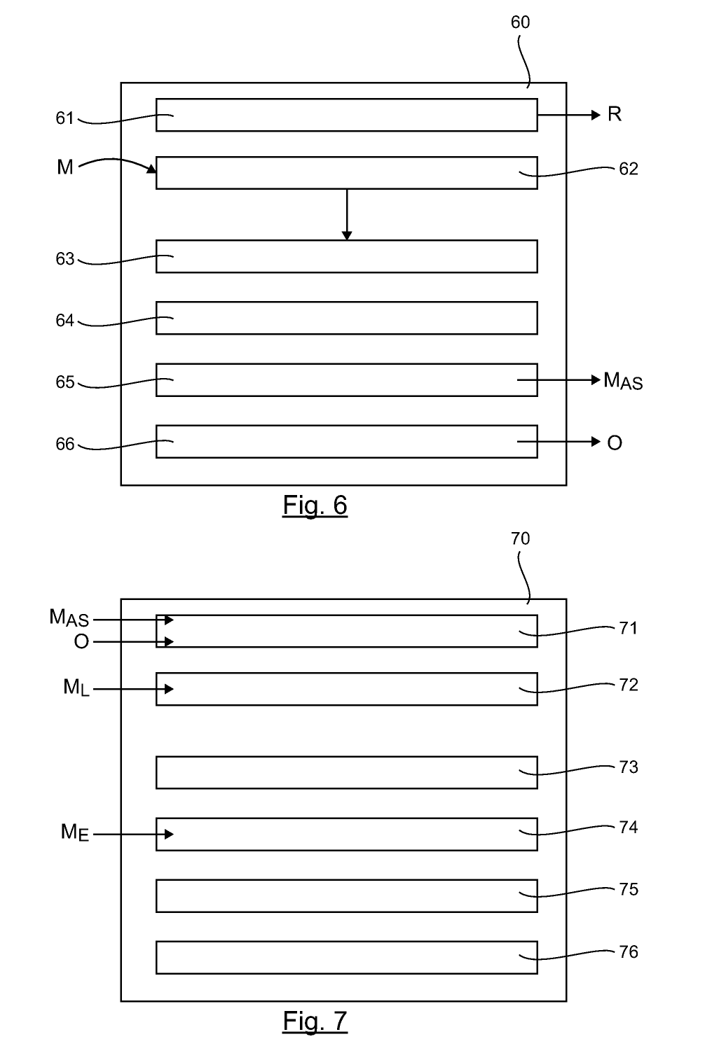

These different phases are described here below with reference to FIGS. 5 to 8 in which the following are represented respectively:
FIG. 5: the steps 51 to 53 of a method 50 for managing software applications implemented by the contents server 41, the indexing step 51 including the steps 511 to 514;
FIG. 6: the steps 61 to 66 of a method for driving 60 implemented by the driver device 421;
FIG. 7: the steps 71 to 76 of method 70 for executing a software application implemented by the rendering device 422.

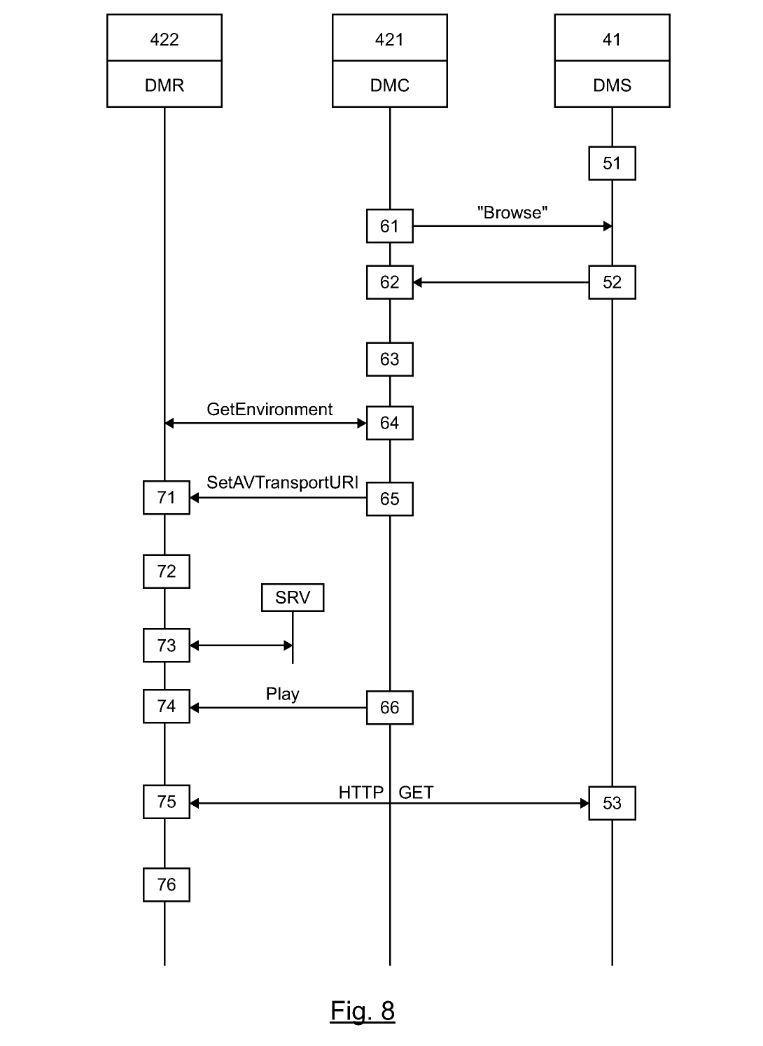

These different steps are represented chronologically in FIG. 8. The description below follows the chronology of these steps.

1. The Indexing of Software Applications According to the Invention

The specific indexing of the invention corresponds to a progress of the usual indexing of the multimedia contents described here above in the UPnP standard, in defining a novel class of objects adapted to the software applications.

The indexing phase implemented within the multimedia contents server 41 comprises four steps for determining and indexing metadata of the software application: a step for determining at least one piece of metadata representing an execution environment 511, indicating especially at least one operating system compatible with the execution of the software module and, as the case may be, compatible with the execution engine required by the software module, a step for determining at least one piece of metadata representing peripherals used by the software application 512, a step for determining at least one piece of metadata representing a location (corresponding for example to a downloading address) and/or an identifier of at least one multimedia content to be rendered by the software application 513 and a step for indexing 514 the software application within a database of the previously determined metadata.

Optionally, the indexing phase can also include a step for determining at least one piece of metadata representing a location (corresponding for example to a downloading address) and/or an identifier of an execution engine associated with the software application if the software module has to be executed by an execution engine.

Thus, each constituent element of the metadata of a software application, for example a video game, is indexed within the list of indexing data so that all these elements are described and available for the devices connected to the network.

As for the multimedia content of a video game type software application, it corresponds by nature to a set of data such as images, textures, 3D models, text, music, sound extracts, etc.

Depending on the game engine, these pieces of data may be:
grouped together within one and the same file (example: “.WAD” file of the Doom game engine);
referenced in an XML type file which indicates the location of all the data files;
or else again stored in a specific tree structure expected by the execution engine.

In the first two cases, the location address of the resource of the UPnP element (image, texture, 3D model, text, music, sound extract, etc.) references a file name. In the last case, the location address of the resource of the UPnP element references the directory containing the data necessary for execution.

One example of a piece of metadata characteristic of a multimedia content of a software application corresponding to a game is especially reproduced in Appendix 1.

For example, by using this specific indexing of the constituent elements of the software applications, the multimedia contents server of a network creates, within its database, a novel class of multimedia contents pertaining to the software applications in addition to the classic classes such as those defined specifically for music, photographs or video.

For each directory serving to index a video game and each characteristic pertaining to this video game, an identification of the “software applications” class to which the software application belongs is used. This class may be derived from the “object.container” class or the “object.item” class, for example:
object.container.applicationContainer or
object.item.applicationItem

An example of an object representation of a software application is reproduced especially in Appendix 1. In this appendix, which is an integral part of the description, the properties highlighted are properties specific to the indexing phase implemented in the method for managing the software application indexing according to the invention. In particular, the “specific:” field corresponds to “vendor specific” properties used to enhance the description of a game according to the invention.

Besides, the pieces of data indexed are updated (515) once a novel software application or a novel version of a software application is detected in the network. Indeed, it can happen that one of the devices connected to the network downloads a novel software application through the Internet (I). The method according to the invention then enables the indexing of this novel software application in order to thereafter share it with the other devices connected to the network.

For example, a user purchases a novel game for a first UPnP device (his personal computer). Following the installation, all the characteristic elements of this novel video game are indexed according to the method described here above. And in the particular case where certain developers of software applications choose to develop a sufficiently generic execution engine, it is possible to download only the multimedia content of this game from the network, if the execution engine of this game is already present on another UPnP device which the user wishes to use to play this game (for example a game console).

According one particular embodiment, the updating can be automatic whenever a novel software application or a novel version of a software application is detected. Thus, the updating makes it possible to automatically improve and optimize the management of the network.

According to another embodiment, it is possible to postpone the updating to a precise time of the day, especially so that this updating is done when the network and more particularly the multimedia contents server is less subjected to use.

2. Obtaining Metadata of Indexed Contents

The driver device 421 sends a “browse” request (61) to obtain, from the multimedia contents server 41, the indexing database containing the metadata of the multimedia contents indexed by the multimedia contents server 41.

In response to a “browse” request sent out by a driver device 421, the multimedia contents server 41 sends (52) all (or part) of the metadata of the indexing base, the driver device 421 receiving (62) the metadata from the multimedia contents server.

As described in detail here below, the metadata transmitted by the multimedia contents server 41 then enables the user, through the driver device 421, to select a multimedia content and especially a software application.

3. Selection of a Content

The driver device 421 is associated with a user interface presenting, to a user, the metadata previously obtained from the indexing database containing a list of multimedia contents to be rendered. The user, through this interface associated with the driver device 421, selects (63) a software application that he wishes to use.

In this case, in this embodiment, the user selects a software application which is a video game.

4. Selection of a Rendering Device 422

In addition to the classic verification of the formats/protocols, the driver device 421 interrogates (64) all the UPnP rendering devices of the network in order to obtain, for each of them, information on the execution environment of the rendering device 422 concerned and of the peripherals of the apparatus implementing this rendering device 422 by invoking the “GetEnvironnmentDescription( )” action of the network connection management service (“ConnectionManager”) of the rendering device 422 described here above.

The execution environment corresponds more specifically to the operating system, the software layers, the drivers of peripherals, etc.

The peripherals which are required to execute the video game are for example the keyboard, the mouse, a handle commonly called a joypad or gamepad (joysticks with buttons or directional crosses) or a joystick.

### First Alternative Embodiment

In this first alternative embodiment, the selection of the software application is done before the selection of the target rendering device: this rendering device uses a filtered list of rendering devices comprising only the rendering devices compatible with the application selected.

First of all, the user obtains the list of multimedia contents and games from a multimedia contents server, from the driver device 421 installed on a mobile telephone and selects a software application, for example in the form of a video game.

The driver device 421 verifies the compatibility of each rendering device 422 of the network with the software application selected according to two “tests” of compatibility already described here above, relating first of all to a comparison of the execution environment and secondly to a comparison of the peripherals of the execution device and the software application.

These two tests deliver a positive or negative result indicating whether the rendering device 422 tested is compatible with the selected software application. At the end of these two tests, only the obtaining of two positive results validates the compatibility of each rendering device 422 with the selected software application.

The driver device 421 analyses all the indexed metadata of the selected video game and proposes, to the user, a list of rendering devices compatible with the selected software application, i.e. those implemented in an apparatus appropriate for the execution of the selected software application. In other words, the driver device 421 carries out a filtering of the rendering devices according to their compatibility with the preliminarily selected software application. The user can then select the rendering device 422 that he wishes to use from this list of compatible rendering devices.

Should several rendering devices be available on the network, the list of devices can be presented in an arbitrary order or in a preferred order depending on a predetermined parameter (memory, capacity of the processor, size of the screen, etc).

From this list of compatible rendering devices, the user then selects a rendering device 422 that he wishes to use.

### Second Alternative Embodiment

In this second alternative embodiment, the selection of the software application is done before the selection of the target rendering device: the latter selection is done from a non-filtered list of rendering devices, comprising all the rendering devices of the network. A check on compatibility is done following these two selections.

According to this second variant, the user obtains the list of multimedia contents and games from a multimedia contents server, using a driver device 421 installed on a mobile telephone and selects a software application, for example in the form of a video game.

Then, through a user interface associated with the driver device 421, the user selects a rendering device 422 that he wishes to use for the execution of a pre-selected software application, or again indicates an order of preference of analysis so that the driver device 421 verifies the compatibility of the rendering devices available according to this order of preference.

Then, the driver device 421 checks to see whether the rendering device 422 selected is compatible with the selected software application or else, if the user has indicated an order of preference, the driver device 421 selects the first rendering device 422 according to the order of preference indicated, the compatibility of which is validated at the end of these two tests.

The test of compatibility used in this second variant is identical to that described here above for the first alternative embodiment.

### Third Alternative Embodiment

In this third variant, the selection of the rendering device 422 is done before the selection of the software application. The check on compatibility is done following these two selections in the same way as in the second alternative embodiment.

Whatever the variant chosen, it is assumed that a software application has been selected and that the selected rendering device 422 is the rendering device 422 compatible with the selected software application.

5. Sending of Metadata of the Selected Software Application

Once the rendering device 422 has been selected, the driver device 421 sends (65) rendering parameters to the selected rendering device 422. These rendering parameters comprise the location address of the selected content to be rendered and the metadata (M_{AS}) of this content which as it happens is a software application: to this end, the driver device 421 invokes the action “SetAVTransportURI” of the “AVTransport” service of the UPnP rendering device 422.

This location address is for example:
a URI address which designates the contents server 41 as the entity from which a data file comprising this software module can be obtained, or else
a URL (Uniform Resource Locator) address which designates a distant server as the entity with which a data file comprising this software module can be obtained.

The metadata transmitted comprises a piece of data representing a location of an execution engine, if the software module of the selected software application requires one such piece of data. This piece of data may for example take the form of an address (for example of a URL type) for downloading from a device connected to the network.

The rendering device 422 receives (71), from the driver device 421, the metadata transmitted by this driver device 421.

The rendering device 422 then analyses the metadata (M_{AS}) transmitted as a parameter of the “SetAVTransportURI”:
a. it extracts especially the properties pertaining to the software module (M_{L}) of the selected multimedia content corresponding to a software application. More specifically, once the rendering device 422 has detected the element representing the software module corresponding to its environment, it uses the information specific to the software module (name, version) to verify that it has the appropriate elements to execute the game. In particular, if the software module requires an execution engine (M_{E}), the rendering device 422 verifies (72) that it truly has the required execution engine.
b. if this is not so, the rendering device 422 uses a location address given by the driver device (421) in the metadata of the selected multimedia content to obtain, (73) for example by downloading, the execution engine appropriate to the environment of the selected multimedia content corresponding to a software application. The downloading of the execution engine is done, according to this example, asynchronously so as not to block the “SetAVTransportURI” action. The execution engine is for example obtained from an Internet server of a game engine provider.
c. the rendering device 422 can also initiate the downloading of the multimedia content (image, texture, 3D model, text, music, sound extract, etc) associated with the software application (selected as a multimedia content), and this downloading can especially be done asynchronously.

For example, if the user wishes to make a one-time use of a software application on a mobile telephone without permanently congesting the execution engine with a large-sized execution engine and/or multimedia content, the mobile telephone, once connected to the network, knows, through the location address distributed by the method of the invention, where it must search for the missing characteristic element, for example the execution engine of the software application when it wishes to use it.

Thus, the method according to the invention offers great flexibility of management of the resources. Indeed, the location of the execution engine is indicated during the distribution phase so much so that the storage of the execution engine (M_{E}) can be adapted to the constraints of the network and not necessarily to the multimedia contents server.

6. Activation of the Execution of the Selected Software Application

Finally, the driver device 421 transmits (66) a rendering command to the selected rendering device 422. This rendering command corresponds to the action “Play( )” of the “AVTransport” service of the rendering device 422.

The rendering device 422 receives (74) the rendering command from the driver device 421 and uses the localizing address of the software module of the selected software application to obtain a data file comprising this software module: the rendering device 422 sends (75) a “GET” type HTTP request to the contents server 41 which in return transmits (53) the requested data file.

7. Execution of the Software Application

Since the rendering command is sent for a content belonging to the “software application” class, the rendering device 422, at the step 76, activates the execution of the selected software application (instead of activating the rendering of a content as it would do for an audio and/or video content) on the apparatus housing the rendering device 422, i.e. it activates the execution, by the operating system of this apparatus, of the selected software application. The software application is then executed by using the peripherals of this apparatus which the user must manipulate to interact with this software application.

The scenario of execution of an indexed software application as a content has been described here above in the case of use of a UPnP module with three boxes (DMC 421, DMR 422, DMS 41). It can be transposed without any difficulty to a UPnP model with two boxes (DMP, DMS) in which the functions of the DMC and those of the DMR are integrated into one and the same UPnP device. In this two-box model, the exchanges by invocation of action between the DMC 421 and the DMR 422 described for the three-box model are replaced by simple function calls.

APPENDIX 1

| | |
|---|---|
| 1. | Example of metadata of a photo according to the UPnP protocol: |

<item id=“2$73688166$805306398” parentID=“2$73688166” restricted=“1”>
<dc:title>Beach</dc:title>
<upnp:album>Vacation</upnp:album>
<dc:date>2009-07-16</dc:date>
<upnp:class>object.item.imageItem.photo</upnp:class>

| | |
|---|---|
| <res size=“19623” resolution=“720×479” | protocolInfo=“http- |

get:*:image/jpeg:DLNA.ORG_PN=JPEG_MED;DLNA.ORG_OP=01;DLNA.ORG_FLAGS=
00f00000000000000000000000000000”>http://192.168.1.15:8055/DLNA-
720×479/photo/beach.jpg</res>

| | |
|---|---|
| <res resolution=“48×32” | protocolInfo=“http- |

get:*:image/jpeg:DLNA.ORG_PN=JPEG_TN;DLNA.ORG_OP=01;DLNA.ORG_CI=1;
DLNA.ORG_FLAGS=00f00000000000000000000000000000”>
http://192.168.1.15:8055/dlna-48×32/photo/plage.jpg</res>
</item>

| 2. | Example of metadata used for the multimedia content of a software application | |
|---|---|---|
| | corresponding for example to a game in Flash language according to the distribution | |
| | method of the invention, according to the UPnP protocol. | |
| | Genre: [String] (ex (e.g.: action, adventure, shoot ‘em up): type of game | |
| | List of compatible Game Engines - Five parameters per Game Engine: | |
| | 1) | Environment [String] (ex: Windows, Linux, Playstation 3, Xbox 360 etc): |
| | | Execution environment of game |
| | 2) | Environment version: [String] |
| | 3) | Name: [String] (ex: Flash, Java, Doom, ScummVM): Name of game engine |
| | 4) | Version: [String] |
| | 5) | Game Engine Provider URL [String]: Address to the game engine provider |
| | | having this game engine available in particular, in the right version and for the |
| | | right environment. |

| | Rating: [Number] (e.g.: 18 and more): Minimum legal age of use. |
|---|---|
| | Difficulty: [String] (e.g.: Easy, Medium, Hard): Overall difficulty of the game. |
| | Lifespan: [Number] (e.g.: 5 hours): Lifespan of the game, i.e. the total game time |
| | planned for an average player. |
| | Required Peripherals: [String list] (e.g.: Keyboard, Joystick): Peripheral necessary for |
| | playing. |
| | Optional Peripherals: [String list] (e.g.: Wheel): Peripherals that might be used with |
| | the game for enhanced experience. |
| 3. | Example of representation of a software application corresponding for example to a |
| | game in Flash language used according to the method of distribution of the invention, |
| | using especially a novel indexation class dedicated to interactive software |
| | applications, according to the UPnP protocol: |

<item id=“2$73688166$805306398” parentID=“2$73688166” restricted=“1”>
<dc:title>Imaginarium</dc:title>
<dc:date>2010-03-16</dc:date>
<upnp:class>object.item.applicationItem</upnp:class>
<res resolution=“720×479” protocolInfo=“http-get:*: software application /x-shockwave-
flash:DLNA.ORG_PN=FLASH>http://192.168.1.15:8055/DLNA-
720×479/game/imaginarium.swf
</res>
<upnp:genre>adventure</upnp:genre>
<specific:life_span>5</specific:life_span>
<specific:required_peripherals>keyboard,joystick</specific:required_peripherals>
<specific:optional_peripherals>wheel</specific:optional_peripherals>
<specific:difficulty>easy</specific:difficulty>
<specific:game_engine environment=“windows” environmentVersion=“XP,Vista,Seven”
name=“Flash” version=“10”>
http://www.adobe.com/win/flash_player.zip
</specific:game_engine>
<specific:game_engine ...>http://...w</specific:game_engine>
</item>

The properties in bold are the properties specific to the indexing phase implemented in the method for distributing a software application according to the invention. In particular, the “specific:” field corresponds to “vendor specific” properties used to enhance the description of a game.

Although the present disclosure has been described with reference to one or more examples, workers skilled in the art will recognize that changes may be made in form and detail without departing from the scope of the disclosure and/or the appended claims.

1. A method for managing at least one software application implemented by a multimedia contents server device, wherein the method comprises:
a phase of the multimedia contents server device indexing, in a content indexing database, at least one software application as content, by recording of pieces of metadata indicating that said content thus indexed is a software application, and recording a location address of a data file comprising a software module designed to execute said at least one software application; and
a phase of the multimedia contents server device transmitting said pieces of metadata and said location address to a driver device serving to select an indexed content to be rendered and to drive the rendering of a selected content.

2. The method according to claim 1, wherein the method comprises a phase of transmitting, to at least one multimedia contents rendering device to which an indexed content is to be rendered, said software module when the indexed content is a software application.

3. The method for managing according to claim 1, wherein said pieces of metadata comprise an identification of a class of contents to which said software application belongs, said class of contents being proper to contents which are software applications.

4. The method according to claim 3, wherein the multimedia contents server device is an UPnP multimedia contents server and said class is a class derived from a UPnP class called an “object.item” class.

5. The method according to claim 3, wherein the multimedia contents server device is an UPnP multimedia contents server and said class is a class derived from a UPnP class called “object.container”.

6. The method for managing a software application according to claim 1, wherein said indexing phase comprises a step for determining and recording at least one piece of metadata representing a location and/or an identifier of at least one multimedia content used by said software application during its execution.

7. The method for managing a software application according to claim 1, wherein said indexing phase furthermore comprises a step for determining and recording at least one piece of metadata representing a location and/or an identifier of an execution engine associated with said software application when said software module needs to be executed by an execution engine.

8. The method for managing a software application according to claim 1, wherein the method also comprises a phase of updating said indexing database when a new version of a software application or when a new software application is detected.

9. A method for driving implemented by a Digital Media Controller (DMC) device, wherein the method comprises:
a step of the DMC device obtaining, from a multimedia contents server, metadata of at least one content indexed in a contents indexing database and a location address of at least one data file associated with said indexed content; and
a step of the DMC device transmitting, to a multimedia content rendering device, metadata, said location address and a command for rendering at least one indexed content;
said command for rendering being intended, when said metadata indicates that said at least one indexed content is a software application, for activating an execution of said software application by means of a software module encoded in said data file.

10. The method for driving according to claim 9, wherein the method comprises a step of verifying compatibility of the rendering device with said indexed content, from a piece of information on an environment of execution of said rendering device and a piece of information representing at least one peripheral of said rendering device.

11. The method for driving according to claim 10, wherein the method comprises:
a first step of verifying an environmental compatibility between:
a piece of metadata representing an environment of execution of said selected multimedia content, and
said at least one piece of information on an environment of execution of said rendering device,
a second step verifying a hardware compatibility between:
a piece of metadata representing peripherals used by said software application; and
said piece of information representing the at least one peripheral of said rendering device.

12. A method for rendering, implemented by a Digital Media Renderer (DMR) device for multimedia contents, wherein the method comprises:
a step of the device receiving, from a location address, pieces of metadata and a command for rendering (O) a content indexed in a multimedia contents indexing database and,
in response to said rendering command, when said pieces of metadata indicate that the indexed content is a software application, a step of the device downloading a software module to said location address and activating execution of said software application by said software module.

13. The method for rendering a software application according to claim 12, wherein the method comprises, when said software module requires an execution engine:
a step of verifying a presence, in the Digital Media Renderer (DMR) device, of an execution engine of said software module;
a step of obtaining (74) said execution engine when said execution engine is absent.

14. A Digital Media Server (DMS) device comprising:
means for indexing, in a content indexing database, at least one software application as content, by recording of metadata indicating that said content thus indexed is a software application and recording a location address of a software module designed to execute said at least one software application;
means for transmitting said metadata and said location address to a Digital Media Controller (DMC) serving to select an indexed content to be rendered and to drive the rendering of a selected content.

15. A Digital Media Controller (DMC) device designed for driving rendering devices, wherein the DMC device comprises:
means for obtaining, from a multimedia contents server, metadata of at least one content indexed in a content indexing database and a location address of at least one data file associated with said indexed content; and
means for transmitting, to a multimedia content rendering device, metadata, said location address and a command for rendering said indexed content, said command for rendering being intended for activating, when said pieces of metadata indicate that said indexed content is a software application, an execution of said software application by means of a software module encoded in said data file.

16. A device for rendering multimedia content comprising:
means for receiving a command for rendering an indexed content in a multimedia content indexing database, a location address of a data file associated with said indexed content and metadata of said indexed content; and
means for downloading a software module to said location address, in response to said rendering command when said pieces of metadata indicate that the indexed content is a software application, and for activating the execution of said software application by means of said software module.
